(19) United States
(12) Patent Application Publication
(10) Pub. No.: US 2007/0214039 A1
(43) Pub. Date: Sep. 13, 2007

(54) Method and system for creating marketing campaigns using stand alone imaging techniques

(75) Inventor: Timothy A. Hoyt, Miami, FL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Picture Marketing, Inc., Miami, FL (US)

(21) Appl. No.: 11/372,841

(22) Filed: Mar. 9, 2006

(51) Int. Cl. G06Q 30/00

(52) U.S. Cl. 705/14

(57) ABSTRACT

Method and system for creating marketing campaigns using stand alone imaging techniques. According to an embodiment, the present invention provides a method for providing custom processing of one or more images. The method includes a step for creating a plurality of different campaigns through an electronic interface. The electronic interface is coupled to a world wide network of computers. The method also includes a step for selecting one of the plurality of campaigns for a selected event associated with the one of the plurality of campaigns. Additionally, the method includes a step for capturing a digital image of a consumer entity using an image capturing device, such as a digital camera, for the selected campaign at the selected event. Moreover, the method includes a step for inputting information associated with the consumer entity. The method additionally includes a step for receiving the information associated with the consumer entity and associating the information with the digital image of the consumer entity.

### BACKGROUND OF THE INVENTION

The present invention relates generally to creating marketing campaigns using stand alone imaging techniques. More particularly, the present invention provides a technique including a method and system for capturing and processing one or more images and distributing them over a wide area network of computers. The invention will generally be illustrated using a wide area network of computers such as the Internet, but it should be recognized that the invention has a much broader range of applicability. For example, the invention can be applied to other types of networks where a physical geographic location is coupled to an electronic medium.

Merchants have always attempted to find ways to lure shoppers to their stores, establishments, and the like, which are often fixed in physical space (e.g., stores, open markets) at a specific geographic location. In particular, merchants placed advertisements in daily newspapers to lure these shoppers to their stores. Merchants also provided shoppers with coupons, special discounts, and bonus points as ways to attract shoppers. In some cases, merchants have even provided special events such as live music, carnivals, magicians, celebrities, and the like as other ways of luring shoppers. Free products such as food, novelty items, and the like have also been used to lure shoppers to the merchant's place. All of these ways have been somewhat successful with conventional merchants that provide their goods or services for display at a physical location.

Shoppers are now using computers for purchasing goods, which are delivered to the shopper's home. In particular, shoppers are purchasing goods and even services from merchants using a world wide area network of computers, commonly known as the Internet. The Internet is an international “super-network” connecting together millions of individual computer networks and computers, workstations, and the like. Although the Internet is widely know for one of its ways of presenting information through the World Wide Web (herein “Web”), there are many other services currently available based upon the general Internet protocols and infrastructure.

The Web is generally easy to use for people with little knowledge about computers. Information on the Web can be presented on electronic “pages” made of graphics and text that contain “links” to other pages either within the same set of data files (i.e., Web site) or within data files located on other computer networks. Users often access information on the Web using a “browser” program. The browser program processes information from Web sites and displays the information using graphics, text, sound, and animation. Accordingly, the Web has become a popular medium for advertising goods and services directly to shoppers.

With the increasing popularity of the Internet, many merchants have flocked to it in an attempt to sell goods and services using an electric medium in the form of the Web site, which can be accessed by computers that are coupled to each other over a wide area network, i.e., Internet. As merely an example, a potential purchaser of a text book can now purchase such book using a service on the Internet from a company called Amazon.com in Seattle, Wash., as well as others. Customers can also purchase goods from auction houses such as those called ebay.com of California and others. Although some success has been achieved using the electronic medium, many drawbacks still exist.

For example, electronic Web pages are often easy to create so electronic Web sites on the Internet have increased dramatically in quantity. Accordingly, it is increasingly more difficult for merchants to lure potential customers to their Web sites because of the sheer number and complexity of Web sites. Additionally, merchants have had difficulty building goodwill and/or awareness of their Web sites, also due to the sheer number of Web sites. In some cases, there are so many Web sites that it is almost impossible or impractical to identify a good to be purchased even with conventional search engines, which often find thousands of potential sites to visit. Additionally, it is often difficult to get personalized information for advertisements and other survey information through web sites and the like. Accordingly, it would be desirable to find a way to lure a potential user to a selected Web site in a more targeted manner. This limitation is also shared by non-merchant Web sites that seek to increase their viewership in order to increase their advertising revenues.

From the above, it can be seen that a more efficient way of obtaining information from customers is highly desirable.

### BRIEF SUMMARY OF THE INVENTION

According to the present invention, techniques for creating marketing campaigns using stand alone imaging techniques are included. More particularly, the present invention provides a technique including a method and system for capturing and processing one or more images and distributing them over a wide area network of computers. The invention will generally be illustrated using a wide area network of computers such as the Internet, but it should be recognized that the invention has a much broader range of applicability. For example, the invention can be applied to other types of networks where a physical geographic location is coupled to an electronic medium.

According to an embodiment, the present invention provides a method for providing custom processing of one or more images. The method includes a step for creating a plurality of different campaigns through an electronic interface. The electronic interface is coupled to a world wide network of computers (e.g., the Internet). The method also includes a step for selecting one of the plurality of campaigns for a selected event associated with the one of the plurality of campaigns. Additionally, the method includes a step for capturing a digital image of a consumer entity using an image capturing device, such as a digital camera, for the selected campaign at the selected event. Moreover, the method includes a step for inputting information associated with the consumer entity. The method additionally includes a step for receiving the information associated with the consumer entity and associating the information with the digital image of the consumer entity. In addition, the method includes a step for associating an identifier with the image of the consumer entity. Additionally, the method includes a step for storing the image of the consumer entity, identifier, and information associated with the consumer entity. Furthermore, the method includes a step for processing the image with a portion of the information. In addition, the method includes a step for forming a directed advertisement including the processed image and personalized template associated with at least a portion of the information. The method additionally includes a step for outputting the directed advertisement. For example, the directed advertisement includes the processed image to the consumer entity. Also the method includes a step for viewing the directed advertisement comprising the processed image by the consumer entity. The method also includes a step for causing an emotional response in the consumer entity by the directed advertisement. Moreover, the method includes a step for initiating a response by the consumer entity by the directed advertisement.

According to an another embodiment, the present invention provides a method for providing custom processing of one or more images. The method includes a step for determining a campaign associated with an event through an electronic interface. The electronic interface is coupled to a world wide network of computers. The method also includes a step for determining what information is to be provided for the campaign from a consumer entity. The method additionally includes a step for determining a template for the campaign. The template is associated with the event. The method additionally includes a step for forming the campaign including the template. In addition, the method includes a step for capturing a digital image of a consumer entity using an image capturing device for the campaign at the event. Moreover, the method includes a step for associating an identifier with the digital image of the consumer entity. The method additionally includes a step for providing information associated with the campaign for the consumer entity. In addition, the method includes a step for receiving the information associated with the campaign for the consumer entity and associating the information with the digital image of the consumer entity. The method also includes a step for storing the digital image of the consumer entity, identifier, and information associated with the consumer entity. In addition, the method includes a step for processing the image with a portion of template information according to the template. The method additionally includes a step for deriving a custom theme based upon at least a portion of the information associated with the campaign for the consumer entity. In addition, the method includes a step for forming a directed advertisement comprising the processed image and the custom theme. The method additionally includes a step for outputting the directed advertisement comprising the processed image and the custom theme to the consumer entity.

According to another embodiment, the present invention provides as system for providing custom processing of one or more images. The system includes one or more computer memories. The one or more memories include one or more codes directed to determining a campaign associated with an event through an electronic interface. The electronic interface is coupled to a world wide network of computers. The one or more memories also include one or more codes directed to receiving what information is to be provided for the campaign from a consumer entity. The one or more memories additionally includes one or more codes directed to identifying a template for the campaign, the template being associated with the event. Additionally, the one or more memories include one or more codes directed to forming the campaign including the template. Moreover, the one or more memory include one or more codes directed to receiving a captured digital image of a consumer entity using an image capturing device for the campaign at the event. The one or more memories additionally includes one or more codes directed to associating an identifier with the image of the consumer entity. Additionally, the one or more memories include one or more codes directed to requesting information associated with the campaign for the consumer entity. The one or more memories also include one or more codes directed to receiving the information associated with the campaign for the consumer entity and associating the information with the digital image of the consumer entity. Moreover, the one or more memory include one or more codes directed to storing the image of the consumer entity, identifier, and information associated with the consumer entity. Additionally, the one or more memories include one or more codes directed to processing the image with a portion of template information according to the template. Moreover, the one or more memory include one or more codes directed to deriving a custom theme based upon at least a portion of the information associated with the campaign for the consumer entity. Additionally, the one or more memories include one or more codes directed to forming a directed advertisement comprising the processed image and the custom theme. The one or more memories also include one or more codes directed to outputting the directed advertisement comprising the processed image and the custom theme to the consumer entity.

According to another embodiment, the present invention provides a system for obtaining and identifying the one or more images. The system is used in a marketing campaign for a first entity where at least one campaign ambassador obtains one or more images of one or more potential customers at a first setting. The one or more images are used to attract the one or more potential customers communicate with the first entity to obtain the one or more images. The system includes a campaigning device being configured to store campaign information associated with the first setting. The campaigning device includes an electronic interface. The electronic interface is connected to a network. The system additionally includes an image capturing device being coupled to the campaigning device. The campaigning device is configured to store the one or more images. The system also includes an input device being coupled to the campaign device. The input device is configured to receive at least one input. Additionally, the system includes a storage device being configured to store the one or more images. According to an embodiment, the one or more images are associated with the at least one input by the campaigning device.

It is to be appreciated to that according to certain embodiments, the present invention provides a system and method for efficient and cost effective marketing campaigns. For example, the present invention provides portable campaigning devices that is flexible, scalable, and usable for a variety of events. It is also to be appreciated that the present invention provides engaging experiences to potential consumers and lures consumers with their own images. According to certain embodiments, the present invention provide secure and enjoyable online experiences for potential consumers.

It is understood the examples and embodiments described herein are for illustrative purposes only and that various modifications or changes in light thereof will be suggested to persons skilled in the art and are to be included within the spirit and purview of this application and scope of the appended claims.

Further understanding of the nature and advantages of the invention may be realized by reference to the remaining portion of the specification, drawings, and attached documents.

### BRIEF DESCRIPTION OF THE DRAWINGS

FIG. 1 is a simplified diagram illustrating a method for creating and using a marketing campaign according to an embodiment of the present invention.

FIG. 1A is a simplified diagram of a marketing campaigning system according to an embodiment of the present invention.

FIGS. 2A and 2B are simplified flow chart diagram illustrating a method for organizing campaign according to an embodiment of the present invention.

FIGS. 3A and 3B are simplified flow chart diagram illustrating a method for organizing campaign according to an embodiment of the present invention.

### DETAILED DESCRIPTION OF THE INVENTION

According to the present invention, techniques for creating marketing campaigns using stand alone imaging techniques are included. More particularly, the present invention provides a technique including a method and system for capturing and processing one or more images and distributing them over a wide area network of computers. The invention will generally be illustrated using a wide area network of computers such as the Internet, but it should be recognized that the invention has a much broader range of applicability. For example, the invention can be applied to other types of networks where a physical geographic location is coupled to an electronic medium.

As described above, conventional marketing techniques often fail to provide enough incentives for customers to supply useful marketing information to merchants or to be interested in a merchant website. It is to be appreciated that according to certain embodiments, the present invention provides a system and method to attract customers or potential users to a selected website in a target manner.

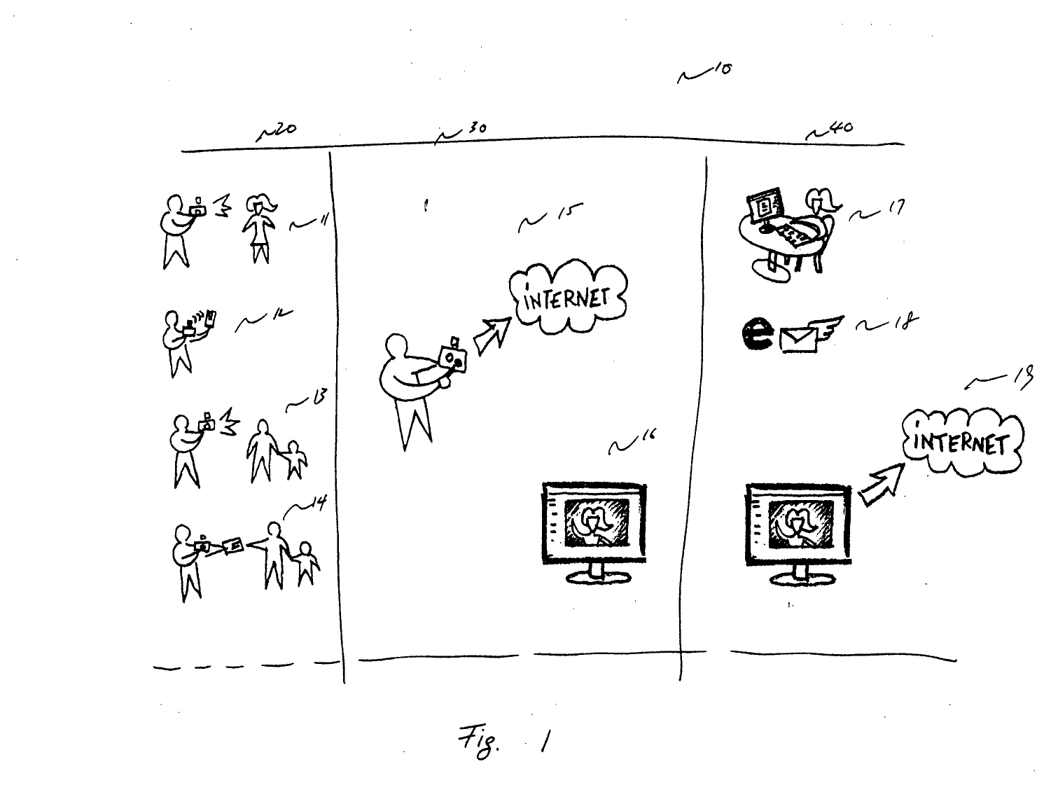

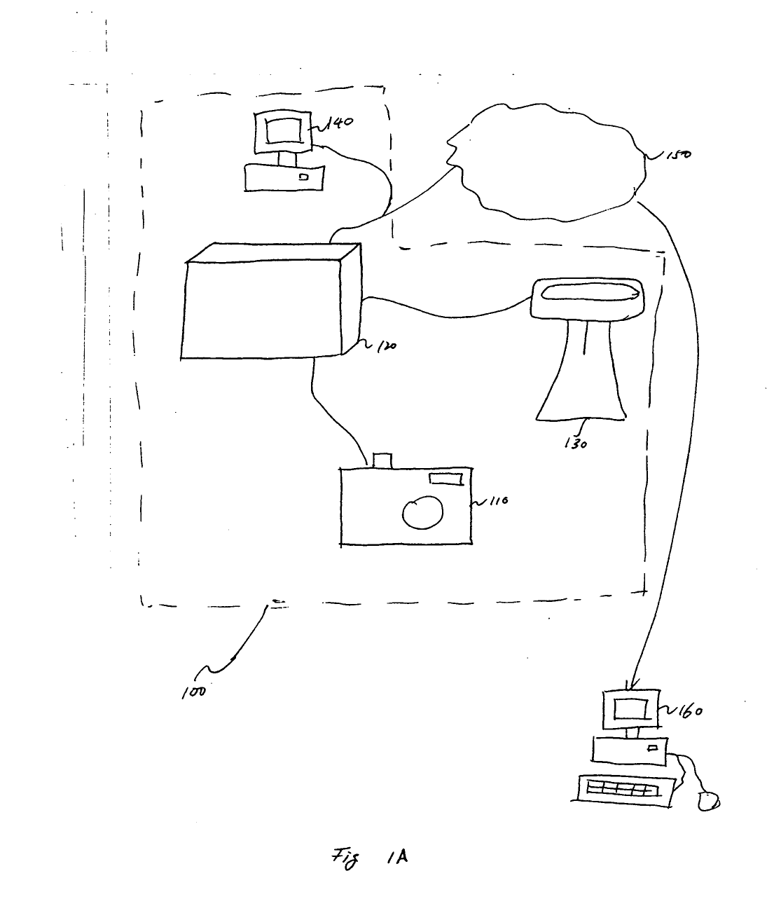

FIG. 1 is a simplified diagram illustrating a method for creating and using a marketing campaign according to an embodiment of the present invention. This diagram is merely an example, which should not unduly limit the scope of the claims. One of ordinary skill in the art would recognize many variations, alternatives, and modifications. The campaigning method 10 includes three stages: an input stage 20, a processing stage 30, and an output stage 40. At the input stage 40, images are captured and identified at a venue. For example, the venue is a kiosk at a marketing event. According to an embodiment, a marketing personnel captures one or more images using a portable campaigning device for a potential customer at step 11. Next, the marketing personnel associates the captured image with an identifier. As an example, the identifier is a barcode card that is to be filled by the potential customers. It is to be appreciated that an image can be associated with more than one identifier, such as show credential, driver's license, company badge, mailing address, email address, facial recognition, thumbprint, DNA, ear print, etc. According to an example, the market personally captures a second image for more than one potential customers at step 13. In addition to associating the captured second image with the identification of the more than one potential customers, the marketing personnel provides a print out of the image to the more than one potential customers.

It is to be appreciated that the present invention provides scalability and flexibility for marketing campaigns. According to various embodiment, the present invention provides a campaigning system to be used for the campaigning method 100. For example, a campaigning system is illustrated according to FIG. 1A.

FIG. 1A is a simplified diagram of a marketing campaigning system according to an embodiment of the present invention. This diagram is merely an example, which should not unduly limit the scope of the claims. One of ordinary skill in the art would recognize many variations, alternatives, and modifications. According to certain embodiments, a marketing campaigning system includes an image capture device 110, a campaigning device 120, an input device 130, and a processing device 140. The campaigning device 120 is coupled to the image capture device 110, the input device 130, and the processing device 140. Depending upon embodiments, the campaigning device 120 is connected to the Internet 150.

According to an embodiment, a marketing personnel carries the campaigning device 120, the input device 130, and the image capture device 110 as a portable system. For example, the campaigning device 120 is a laptop computer, the image capture device 110 is a digital camera, and the input device 130 is a barcode scanner. It is to be appreciated that a portable system allows easily deployment of marketing personnel. In addition, the portability allows high speed operation, as the marketing personnel is able to carry the portable system from customer to the next. For example, a marketing personnel is able to carry the portable system to conduct marketing campaign at a bar or a sport event. According to certain embodiments, the present invention is scalable. For example, hundreds of portable systems can be used by hundreds of marketing personnel to conduct market campaign.

According to an embodiment, the image capture device 110 is a CCD based digital camera that is capable of producing high quality images and easy to use. For example, the digital camera is a light weight point-and-shoot digital camera that allows marketing personnel to carry to different locations and shoot in crowded environments. Additionally, the digital camera is capable of capturing hundreds of photos per battery charge. Depending upon applications, other image capture devices, such as camera phones or video camcorder, can be used to capture images of potential customers. The image capture device 110 is generally light and easily carried. For certain applications, the image capture device 110 can be mounted on a tripod or used as a part of photo station. It is to be appreciated that the present invention provides a high degree of flexibility. For example, the image capture device 110 includes off camera flash units and tripod to capture high quality images.

According to an embodiment, the campaigning device 120 is a portable computing device, which may be implemented with a personal digital assistant (PDA) or a laptop computer. For example, a laptop computer is configured to be used as the campaigning device 120, which contains a marketing campaigning software. In addition, the laptop computer has various electronic ports that allows between laptop and peripherals such as digital cameras and bar code scanners. It is to be appreciated the implement of the campaigning device is flexible and portable. For example, a generic laptop may be configured with marketing campaign software and issued to marketing personnel. The laptop, along with image capture device and input device can be easily set up at a kiosk during a marketing event. The laptop can additionally be used to display captured image to potential customers.

The campaigning device 120 can also be implemented using a PDA that is specifically loaded with marketing campaigning software and configured to be able to connected to image capture and other input devices. According to an embodiment, a portable marketing campaign device is implemented using a PDA, a digital camera, and a barcode scanner. A marketing personnel is able to carry the portable marketing campaign device on person and captures images of potential customers in a crowd.

The campaigning device 120 can use a different types of input devices. According to an example, a barcode scanner is used as an input device. According to an embodiment, when a marketing personnel captures an image, the potential customer whose image is capture receives a card that contains a barcode and a web address. The market personnel links the barcode and the web address, which is to be constructed later, to the capture image. The campaigning device 120 obtains the barcode from the barcode reader and associate the barcode with the capture image. As a result, the capture image is properly associated and identified with the potential customer.

According to various embodiments, other types o input devices may be used. For example, keyboard, keypad, mouse, scanner, etc. are used as input devices. For example, before or after capture an image, the customer may provide her contact information using a keyboard. According to an embodiment, the input device is a scanner that is used to scanner identification information, such as driver's license and business card, of a potential customer. It is to be appreciated that, according to various embodiments, the present invention obtains customers' biometrics, such as facial recognition, thumb print, DNA, ear print, etc. These biometrics are then associated to the captured images using the campaigning device 120. According to an embodiment, captured images are associated with survey forms that are handed out by a marketing personnel.

Now referring back to FIG. 1. The input state 20 can be repeated. For example, the process of capturing images and associating identification information continues until the end of a marketing event. It is to be appreciated that because of the portability and flexibility of various embodiments, the present invention makes it easier for market personnel to conduct marketing campaigns. In addition, because of the novelty of the present invention provides, a marketing personnel using the present invention is able to deliver engaging experiences from beginning to end. High quality image captures enable the marketing personnel to create memorable photos they can later be used to “lure” customers to complete marketing surveys or visit a merchant web site.

After the marketing campaign, the market personnel processes captured images at step 15. For example, the marketing personnel transfers images and information associated with customers to a data server. According to an example, the data server is the workstation 140, which is connected to the Internet According to various embodiments, processing includes photo analysis. As an example, a compute analyzes the race, sex, age, location, time and date, etc. associated with the captured image. It is to be appreciated that according to various embodiments, the present invention provides securely linked photos and data. Today in a digital age where identity thefts have been an alert problem, data security and privacy are critical aspects of any lead generation system. According to an embodiment, the present invention ensures that contact information, survey questions, and photos are securely linked together, and no one sees anyone else's photo. As an example, photos are tagged with a unique ten-digit code at time of data capture. Survey responses are reliably linked to a single contact and one captured photo. Photo subjects in group photos are individually tracked with unique codes. New leads and reporting can be downloaded securely at any time with 128-bit encryption.

According to an embodiment, the workstation 140 is used to track the productivity of marketing personnel. For example, the workstation 140 summarizes the surveys conducted by a market personnel based on the number of images captured. It is to be appreciated the productive tracking offered by the present invention is more accurate than most of the conventional system where marketing personnel simply hand out printed copies of survey forms.

During the processing, unique marketing survey forms can be generated. For example, the workstation 140 generates a survey form that is uniquely related to cycling based on the characteristics of the customer. As an another example, the workstation 140 generates a customized web page targeting a customer with a certain set of shopping preference based on the information of a survey associated with that customer's image.

After processing, images are ready for viewing at step 16. A customer whose image has been captured access uses a personal computer at step 17. The customer is informed that their image is ready to be viewed online at step 18. For example, the customer receives an email informing her that her image is ready. As another example, the customer is provided the web site address and access information. According to various embodiments, the customer is request to complete a marketing survey before being able to view her image. At step 19 the customer views the image at step 19 through the Internet.

FIG. 1 is merely an example, which should not unduly limit the scope of claims. One of ordinary skill in the art would recognize many variations, alternatives, and modifications. According to various embodiments, various steps of the method 10 may be added, removed, modified, replaced, overlapped, partially-overlapped, or repeated.

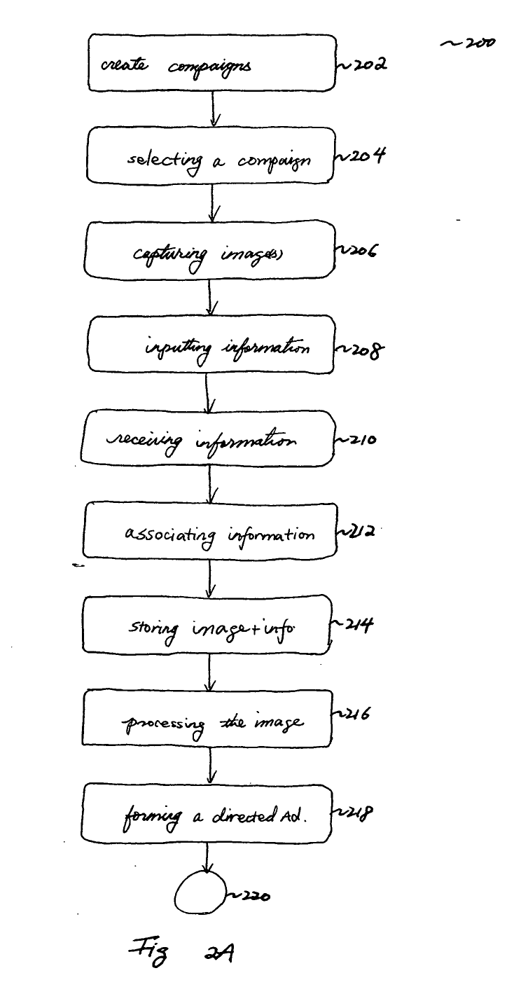

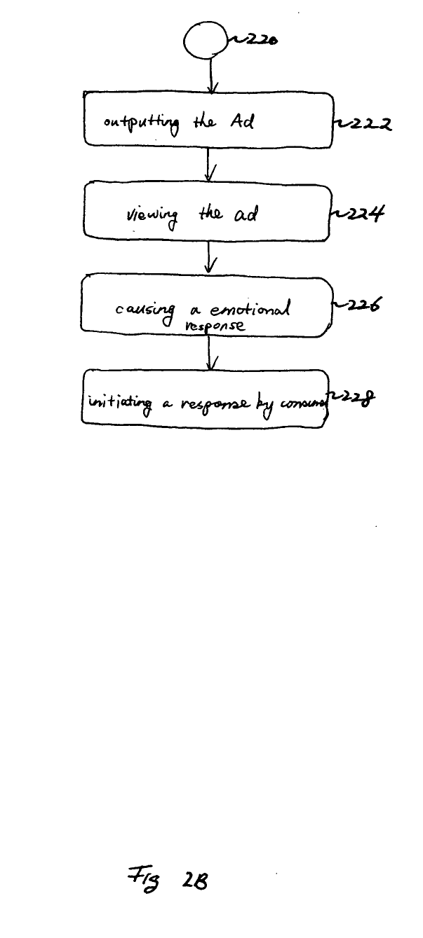

There are various embodiments of the present invention. FIGS. 2A and 2B are simplified flow chart diagram illustrating a method for organizing campaign according to an embodiment of the present invention. This diagram is merely an example, which should not unduly limit the scope of the claims. One of ordinary skill in the art would recognize many variations, alternatives, and modifications. In general, the method 200 is used to provide custom processing of images for the purpose of marketing campaign. As merely an example, the method 200 is implemented using the campaigning system 100 from FIG. 1A.

Usually, the method starts with creating a plurality of different campaigns through an electronic interface, at step 202. For example, campaigns include promoting a new beer brand and a new line of hair products. According to an embodiment, the electronic interface is connected to a world wide network of computers, e.g., the Internet.

Usually, for a particular campaign, a campaign manager selects one of the campaigns for a selected event, at step 204. For example, a campaign for a new beer is selected for a football game party event.

During the selected event, one or more marketing personnel are deploy to capture images of potential customers, at step 206. For example, a marketing personnel captures a digital image of a consumer using digital camera during a football game party.

Depending upon embodiments, various types of information are obtained from potential consumers, at step 208. For example, information sheets is filled by potential consumers. As another example, barcodes are scanned from a market literatures that are distributed to potential consumers.

A campaigning device receives the information associated with potential consumers and associates the information with the digital image of the consumer entity, at step 210. According to an embodiment, the information associated with potential consumers includes one or more identifiers. For example, an identifier is a unique ten-digital number that is obtained from the barcode scanner. The campaigning device associates an identifier with the image of the consumer, at step 212. For example, the campaigning device links the identifier with the image the consumer with a special link file.

The campaigning devices stores the image of the consumer entity, identifier, and information associated with the consumer, at step 214. For example, the campaigning device is a laptop computer that includes a hard drive that is configured to store image of the consumer entity, identifier, and information associated with the consumer according to specific type of file structure.

According to an embodiment, a marketing personnel takes the image and a portion of information for processing, at step 216. For example, the marketing personnel takes the campaigning devices back to an office for the image and a portion of information to be processed by a workstation. As merely an example, the processing of the image includes cataloging the image according to the portion of information and optimizing the image for display on a computer screen.

A directed advertisement is formed, at 218. According to an embodiment, the directed advertisement includes the processed image and personalized template associated with at least a portion of the information. For example, a template for alcoholic beverages is created for an image that is obtained at a local pub. The directed advertisement is then outputted to the consumer, at step 222. For example, a workstation automatically sends an email to the consumer and invites the consumer to view the image, along with the directed advertisement, on the Internet.

The consumer views the directed advertisement and the processed image, at step 224. For example, the consumer views the directed advertisement and the processed image on a personal consumer that access the image via the Internet. The viewing of the directed advertisement and the processed image causes the consumer an emotional response, at step 226. For example, the consumer links the happy memory associated with the image with an advertised product that is a part of the directed advertisement. The consumer initiates a response because of the directed advertisement, at step 228. For example, after viewing an beer advertisement the consumer goes to a convenient store to purchase a pack of beers.

FIGS. 2A and 2B merely provide an example, which should not unduly limit the scope of claims. One of ordinary skill in the art would recognize many variations, alternatives, and modifications. According to various embodiments, various steps of the method 200 may be added, removed, modified, replaced, overlapped, partially-overlapped, or repeated.

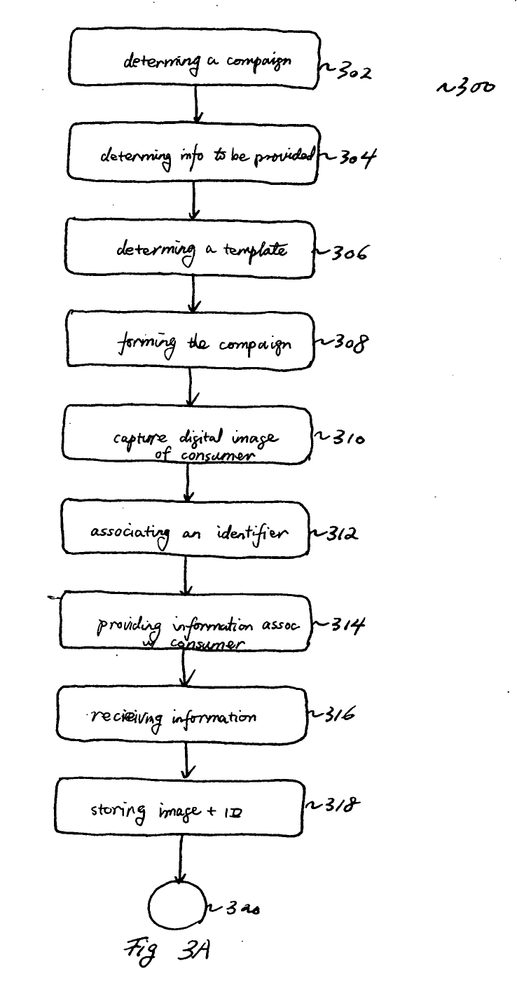

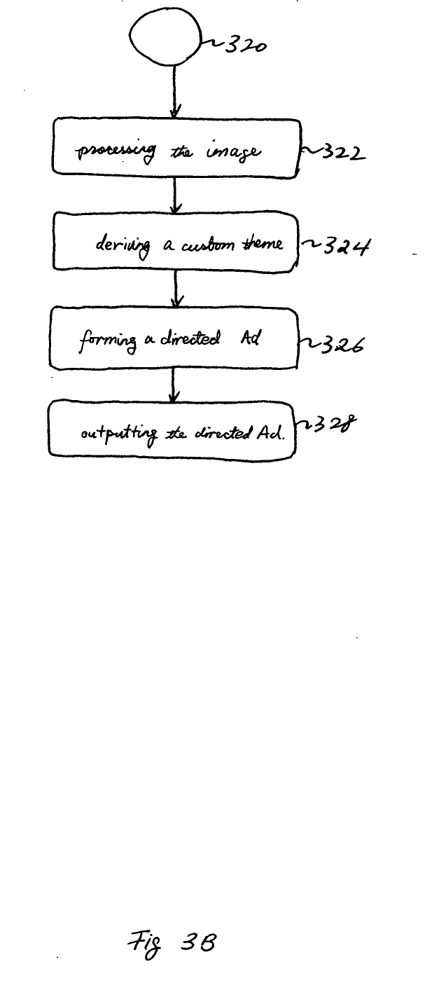

FIGS. 3A and 3B are simplified flow chart diagram illustrating a method for organizing campaign according to an embodiment of the present invention. This diagram is merely an example, which should not unduly limit the scope of the claims. One of ordinary skill in the art would recognize many variations, alternatives, and modifications. In general, the method 300 is used to provide custom processing of images for the purpose of marketing campaign. As merely an example, the method 200 is implemented using the campaigning system 100 from FIG. 1A.

Usually, the method starts with determining a campaign associated with an event through an electronic interface, at step 302. For example, the campaigning is for promote a new brand of beer at an sporting event. According to an embodiment, the electronic interface is connected to a world wide network of computers. For example, the world wide network of computers is the Internet

Once the campaign is determined, the information that is need to be provided for the campaign from one more consumers is determined, at step 304. For example, the information from a consumer includes the consumer's background, lifestyle, and drinking habit. To obtain the information, a template is determined, at step 306. According to an embodiment, the template is specifically designed for the event. For example, templates include information about football teams for a football party event. A campaigned is formed to include the template, at step 308.

According to certain embodiments, campaigns are carried out by marketing personnel. During the event, a marketing captures a digital image of a consumer using an image capturing device for the campaign at the event, at step 310. For example, the image capturing device is a digital camera. After capturing, the image is associated with an identifier for the consumer, at step 312. According to various embodiments, the present invention my implement with different types of identifiers such as bar code, finger print, facial features, business card, address, etc. The identifier is associated with the image of the consumer at step 314. The consumer provides information associated with the campaign for the consumer, at step 316. The information associated with the campaign for the consumer is received, and the information is associated with the digital image of the consumer are stored, at step 318.

The image with a portion of template information according to the template is processed, at step 322. A custom theme based upon the information associated with the campaign for the consumer entity is derived, at step 324. A directed advertisement including the processed image and the custom theme is formed, at step 326. The directed advertisement, which includes the processed image and the custom theme to the consumer entity, is outputted, at step 368.

FIGS. 3A and 3B merely provide an example, which should not unduly limit the scope of claims. One of ordinary skill in the art would recognize many variations, alternatives, and modifications. According to various embodiments, various steps of the method 300 may be added, removed, modified, replaced, overlapped, partially-overlapped, or repeated.

According to an embodiment, the present invention provides as system for providing custom processing of one or more images. The system includes one or more computer memories. The one or more memories include one or more codes directed to determining a campaign associated with an event through an electronic interface. The electronic interface is coupled to a world wide network of computers. The one or more memories also include one or more codes directed to receiving what information is to be provided for the campaign from a consumer entity. The one or more memories additionally includes one or more codes directed to identifying a template for the campaign, the template being associated with the event. Additionally, the one or more memories include one or more codes directed to forming the campaign including the template. Moreover, the one or more memory include one or more codes directed to receiving a captured digital image of a consumer entity using an image capturing device for the campaign at the event. The one or more memories additionally includes one or more codes directed to associating an identifier with the image of the consumer entity. Additionally, the one or more memories include one or more codes directed to requesting information associated with the campaign for the consumer entity. The one or more memories also include one or more codes directed to receiving the information associated with the campaign for the consumer entity and associating the information with the digital image of the consumer entity. Moreover, the one or more memory include one or more codes directed to storing the image of the consumer entity, identifier, and information associated with the consumer entity. Additionally, the one or more memories include one or more codes directed to processing the image with a portion of template information according to the template. Moreover, the one or more memory include one or more codes directed to deriving a custom theme based upon at least a portion of the information associated with the campaign for the consumer entity. Additionally, the one or more memories include one or more codes directed to forming a directed advertisement comprising the processed image and the custom theme. The one or more memories also include one or more codes directed to outputting the directed advertisement comprising the processed image and the custom theme to the consumer entity. For example, the present embodiment is illustrated according to FIGS. 3A and 3B.

According to another embodiment, the present invention provides a system for obtaining and identifying the one or more images. The system is used in a marketing campaign for a first entity where at least one campaign ambassador obtains one or more images of one or more potential customers at a first setting. The one or more images are used to attract the one or more potential customers communicate with the first entity to obtain the one or more images. The system includes a campaigning device being configured to store campaign information associated with the first setting. The campaigning device includes an electronic interface. The electronic interface is connected to a network. The system additionally includes an image capturing device being coupled to the campaigning device. The campaigning device is configured to store the one or more images. The system also includes an input device being coupled to the campaign device. The input device is configured to receive at least one input. Additionally, the system includes a storage device being configured to store the one or more images. According to an embodiment, the one or more images are associated with the at least one input by the campaigning device. For example, the present embodiment is illustrated according to FIGS. 1 and 1A.

It is to be appreciated to that according to certain embodiments, the present invention provides a system and method for efficient and cost effective marketing campaigns. For example, the present invention provides portable campaigning devices that is flexible, scalable, and usable for a variety of events. It is also to be appreciated that the present invention provides engaging experiences to potential consumers and lures consumers with their own images. According to certain embodiments, the present invention provide secure and enjoyable online experiences for potential consumers.

Other embodiments of the present invention and its individual components will become readily apparent to those skilled in the art from the foregoing detailed description. As will be realized, the invention is capable of other and different embodiments, and its several details are capable of modifications in various obvious respects, all without departing from the spirit and the scope of the present invention. As merely an example, the present method and booth can be implemented into a telephone network to create an internet telephone booth. The internet telephone booth can transmit and receive video and audio information from a selected e-mail location or phone number. Additionally, messages from the internet telephone booth can be left at selected web sites or even e-mail addresses or the like. Accordingly, the drawings and detailed description are to be regarded as illustrative in nature and not as restrictive. It is therefore not intended that the invention be limited except as indicated by the appended claims.

What is claimed is:

1. A method for providing custom processing of one or more images, the method comprising:
creating a plurality of different campaigns through an electronic interface, the electronic interface being coupled to a world wide network of computers;
selecting one of the plurality of campaigns for a selected event associated with the one of the plurality of campaigns;
capturing a digital image of a consumer entity using an image capturing device for the selected campaign at the selected event;
inputting information associated with the consumer entity;
receiving the information associated with the consumer entity and associating the information with the digital image of the consumer entity;
associating an identifier with the image of the consumer entity;
storing the image of the consumer entity, identifier, and information associated with the consumer entity;
processing the image with a portion of the information;
forming a directed advertisement including the processed image and personalized template associated with at least a portion of the information;
outputting the directed advertisement comprising the processed image to the consumer entity;
viewing the directed advertisement comprising the processed image by the consumer entity;
causing an emotional response in the consumer entity by the directed advertisement; and
initiating a response by the consumer entity by the directed advertisement.

2. The method of claim 1 wherein the electronic interface is selected from a web site or an operating system.

3. The method of claim 1 wherein the image capturing device is a CCD camera.

4. The method of claim 1 wherein the information is personal information associated with the consumer entity.

5. The method of claim 1 wherein the identifier is a bar code.

6. The method of claim 1 wherein the identifier is a facial expression.

7. The method of claim 1 wherein the identifier is a finger print.

8. The method of claim 1 wherein the outputting of the processed image is video information.

9. The method of claim 8 wherein the video information is provided through a cable network.

10. The method of claim 1 wherein the storing is provided on one or more mass storage device coupled to the world wide network of computers.

11. The method of claim 1 wherein the causing the emotion comprises capturing an attention of the consumer entity.

12. The method of claim 1 wherein the consumer entity is a human being.

13. The method of claim 1 wherein the response is a purchase of an item and/or event associated with the directed advertisement.

14. The method of claim 1 wherein the processed image is a personal image of the consumer entity.

15. The method of claim 1 wherein the plurality of campaigns are provided on a campaign manager server, the campaign manager server being coupled to the world wide network of computers.

16. The method of claim 1 wherein the forming further associates a consumer advertisement with the processed image and the personalized template.

17. The method of claim 1 wherein the emotional response is a biological human interest of the consumer entity.

18. The method of claim 1 wherein the creating the campaign comprises determining what information is to be provided associated with the consumer entity for the campaign and selecting a template for the personalized template.

19. The method of claim 1 wherein the information is provided into a survey for the consumer entity.

20. A method for providing custom processing of one or more images, the method comprising:
determining a campaign associated with an event through an electronic interface, the electronic interface being coupled to a world wide network of computers;
determining what information is to be provided for the campaign from a consumer entity;
determining a template for the campaign, the template being associated with the event;
forming the campaign including the template;
capturing a digital image of a consumer entity using an image capturing device for the campaign at the event;
associating an identifier with the digital image of the consumer entity;
providing information associated with the campaign for the consumer entity;
receiving the information associated with the campaign for the consumer entity and associating the information with the digital image of the consumer entity;
storing the digital image of the consumer entity, identifier, and information associated with the consumer entity;
processing the image with a portion of template information according to the template;
deriving a custom theme based upon at least a portion of the information associated with the campaign for the consumer entity;
forming a directed advertisement comprising the processed image and the custom theme; and
outputting the directed advertisement comprising the processed image and the custom theme to the consumer entity.

21. The method of claim 20 wherein the electronic interface is selected from a web site or an operating system.

22. The method of claim 20 wherein the image capturing device is a CCD camera.

23. The method of claim 20 wherein the information is personal information associated with the consumer entity.

24. The method of claim 20 wherein the identifier is a bar code.

25. The method of claim 20 wherein the identifier is a facial expression.

26. The method of claim 20 wherein the identifier is at least one finger print.

27. The method of claim 20 wherein the processed image is video information.

28. The method of claim 27 wherein the video information is provided through a cable network.

29. The method of claim 20 wherein the storing is provided on one or more mass storage device coupled to the world wide network of computers.

30. The method of claim 20 wherein the consumer entity is a human being.

31. The method of claim 20 wherein the processed image is a personal image of the consumer entity.

32. The method of claim 20 wherein the forming further associates a consumer advertisement with the processed image and the personalized template.

33. The method of claim 20 wherein the information is provided into a survey for the consumer entity.

34. The method of claim 20 further comprising transferring the campaign to the image capturing device.

35. A system for providing custom processing of one or more images, the system comprising one or more computer memories, the one or more memories including:
one or more codes directed to determining a campaign associated with an event through an electronic interface, the electronic interface being coupled to a world wide network of computers;
one or more codes directed to receiving what information is to be provided for the campaign from a consumer entity;
one or more codes directed to identifying a template for the campaign, the template being associated with the event;
one or more codes directed to forming the campaign including the template;
one or more codes directed to receiving a captured digital image of a consumer entity using an image capturing device for the campaign at the event;
one or more codes directed to associating an identifier with the image of the consumer entity;
one or more codes directed to requesting information associated with the campaign for the consumer entity;
one or more codes directed to receiving the information associated with the campaign for the consumer entity and associating the information with the digital image of the consumer entity;
one or more codes directed to storing the image of the consumer entity, identifier, and information associated with the consumer entity;
one or more codes directed to processing the image with a portion of template information according to the template;
one or more codes directed to deriving a custom theme based upon at least a portion of the information associated with the campaign for the consumer entity;
one or more codes directed to forming a directed advertisement comprising the processed image and the custom theme; and
one or more codes directed to outputting the directed advertisement comprising the processed image and the custom theme to the consumer entity.

36. The system of claim 35 wherein the electronic interface is selected from a web site or an operating system.

37. The system of claim 35 wherein the image capturing device is a CCD camera.

38. The system of claim 35 wherein the information is personal information associated with the consumer entity.

39. The system of claim 35 wherein the identifier is a bar code.

40. The system of claim 35 wherein the identifier is a facial expression.

41. The system of claim 35 wherein the identifier is at least one finger print.

42. The system of claim 35 wherein the consumer entity is a human being.

43. The system of claim 35 wherein the processed image is a personal image of the consumer entity.

44. The system of claim 35 wherein the information is provided into a survey for the consumer entity.

45. The system of claim 35 further comprising one or more codes directed to transferring the campaign to the image capturing device.

46. In a marketing campaign for a first entity where at least one campaign. ambassador obtains one or more images of one or more potential customers at a first setting, the one or more images being used to attract the one or more potential customers communicate with the first entity to obtain the one or more images, a system for obtaining and identifying the one or more images comprising:
a campaigning device being configured to store campaign information associated with the first setting, the campaigning device including an electronic interface, the electronic interface being connected to a network;
an image capturing device being coupled to the campaigning device, the campaigning device being configured to store the one or more images;
an input device being coupled to the campaign device, the input device being configured to receive at least one input;
a storage device being configured to store the one or more images;
wherein:
the one or more images are associated with the at least one input by the campaigning device.

47. The system of claim 46 wherein the image capture device is a digital camera.

48. The system of claim 46 wherein the input device is a bar code scanner.

49. The system of claim46 wherein campaigning device is a portable computer.

50. The system of claim 46 wherein the network is a wide area network.

51. The system of claim 46 wherein campaigning device is a portable digital assistant.

52. The system of claim 46 furthering comprising a display being configured to show the one or more images.
